(19) United States
(12) Patent Application Publication
(10) Pub. No.: US 2021/0028432 A1
(43) Pub. Date: Jan. 28, 2021

(54) BATTERY

(71) Applicant: Ningde Amperex Technology Ltd., Ningde (CN)

(72) Inventors: Jiaxi ZHANG, Ningde (CN); Shasha Wang, Ningde (CN)

(21) Appl. No.: 16/662,223

(22) Filed: Oct. 24, 2019

(30) Foreign Application Priority Data
Jul. 22, 2019 (CN) 201910663165.X

(51) Int. Cl. H01M 2/26; H01M 2/06

(52) U.S. Cl. CPC H01M 2/26; H01M 2/06

(57) ABSTRACT

A battery not employing soldered joints includes a package case and a first electrode plate disposed in the package case. The first electrode plate includes a current collector for connecting to an active material layer, and the current collector is provided with a plurality of first tab pieces. The first tab pieces are stacked and fixedly connected to form a first tab unit, and the first tab unit extends out of the package case. The disclosed battery reduces the space occupied by the tab unit by directly arranging the tab unit on the current collector of the first electrode plate without soldering an additional tab unit thereto. Energy density of the battery is thus increased.

### FIELD

The present disclosure relates to electrochemical field, and more particular to a battery.

### BACKGROUND

In process of manufacturing large or high-rate batteries, a lead-out tab is used to connect to a multi-layer current collector. Since soldering technique is used during process of connecting the tab with the multi-layer current collector, a soldered structure between the tab and the multi-layer current collector requires extra space, causing loss of battery energy density, and the resistance of the soldered joint can be large. A large amount of heat can thus collect at the soldered joint. If the joint cannot be cooled timely, the battery will overheat, which can affect performance of the battery, and even cause an accident. Soldering tab does not guarantee the consistency of the joints, and an accumulation of resin and possibility of breakage may affect the performance of the battery.

Thus, there is room for improvement within the art.

### SUMMARY

A battery is disclosed.

In an embodiment, the battery of the disclosure includes a package case and a first electrode plate disposed in the package case. The first electrode plate includes a current collector for connecting to an active material layer, and the current collector is provided with a plurality of first tab pieces. The plurality of first tab pieces are stacked and connected together to form a first tab unit, and a part of the first tab unit extends out of the package case.

Furthermore, in another embodiment, the plurality of first tab pieces are fixed by an adhesive.

Furthermore, in another embodiment, through holes are defined on each of the plurality of first tab pieces. The adhesive is disposed at a position where the through holes are located and fills the through holes.

Furthermore, in another embodiment, the adhesive is disposed on a side surface of the first tab unit.

Furthermore, in another embodiment, the adhesive is disposed between adjacent two of the first tab pieces.

In another embodiment, the battery further includes a second electrode plate. The second electrode plate having a polarity opposite to a polarity of the first electrode plate. The second electrode plate includes a current collector for connecting to an active material layer, and the current collector is provided with a plurality of second tab pieces. The plurality of second tab pieces are stacked and connected together to form a second tab unit. The second tab unit partially extends out of the package case.

Furthermore, in another embodiment, the plurality of second tab pieces are fixedly connected by an adhesive.

Furthermore, in another embodiment, through holes are defined on each of the plurality of second tab pieces. The adhesive is disposed at a position where the through holes are located and fills the through holes.

Furthermore, in another embodiment, the adhesive is disposed on a side surface of the second tab unit.

Furthermore, in another embodiment, the first tab unit and the second tab unit extend from the same side of the battery. The first tab unit and the second tab unit are connected by adhesive.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a structural diagram of an unwound electrode plate of a battery in an embodiment.

FIG. 2 is a schematic exploded diagram of electrode plates of a battery.

FIG. 3 is a schematic diagram of a battery cell assembled by the electrode plate of FIG. 1.

FIG. 4 is a cross-sectional view of FIG. 3 along line IV-IV.

FIG. 5 is a cross-sectional diagram of the battery cell of FIG. 3 with tab pieces pressed together.

FIG. 6 is a schematic diagram showing tab pieces of the battery cell of FIG. 3 fixed by adhesive in an embodiment.

FIG. 7 is a cross-section view of FIG. 6 along line VII-VII.

FIG. 8 is a schematic diagram showing tab pieces of the battery cell of FIG. 3 fixed by adhesive in another embodiment.

FIG. 9 is a structural diagram of a battery in an embodiment.

### DETAILED DESCRIPTION

The present application will be described with reference to the accompanying drawings. A number of details are set forth in the following description so as to fully understand the present application. However, the present application can be implemented in many other ways different from those described herein, and those skilled in the art can make improvements without violating the contents of the present application. Therefore, the present application is not to be considered as limiting the scope of the embodiments described herein.

Unless otherwise defined, all technical and scientific terms used herein have the same meaning as commonly understood by one skilled in the art. The terms used in specification of the present application herein are only for describing specific embodiments, and are not intended to limit the present application.

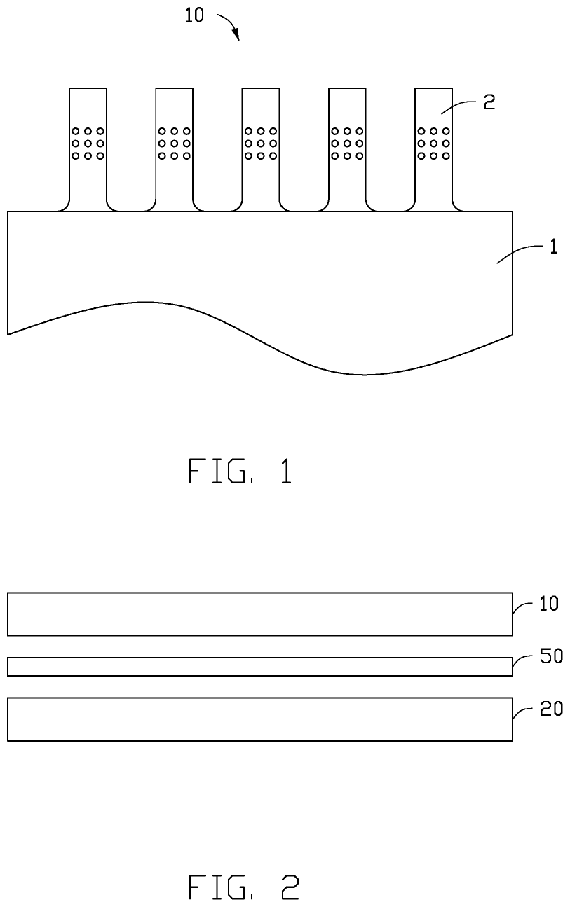

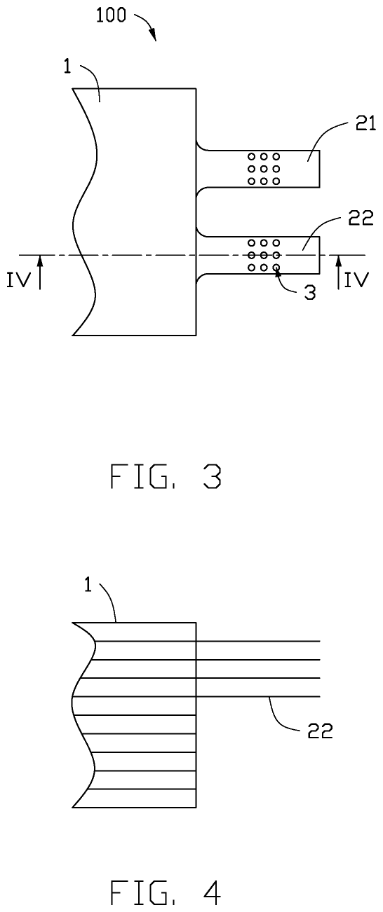

Referring to FIGS. 1 to 4 and FIG. 9, the battery 200 includes a battery cell 100 and a package case 201. The battery cell 100 is packaged within the package case 201. The battery cell 100 includes a first electrode plate 10. The first electrode plate 10 includes a current collector 1 for connecting to an active material layer, and the current collector 1 is provided with a plurality of first tab pieces 2. The first tab pieces 2 are integrally formed with the current collector 1. In some embodiments, the plurality of the first tab pieces 2 may be formed on one side of the current collector 1 by cutting the side of the current collector 1. The preferred shape of the plurality of the first tab pieces 2 and the current collector 1 is shown in FIG. 1.

The battery cell 100 further includes a second electrode plate 20. The second electrode plate 20 having a polarity opposite to a polarity of the first electrode plate 10. The structure of the second electrode plate 20 is substantially the same as the structure of the first electrode plate 10. The second electrode plate 20 includes a current collector for connecting to an active material layer, and the current collector is provided with a plurality of second tab pieces. The plurality of second tab pieces have the same structure but opposite polarities as the first tab pieces 2.

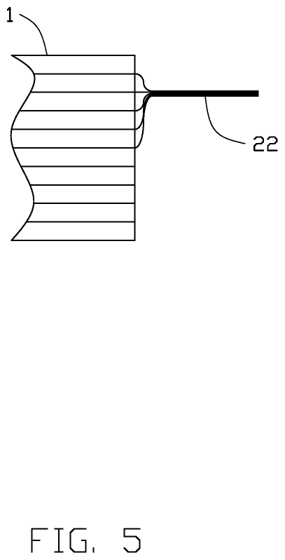

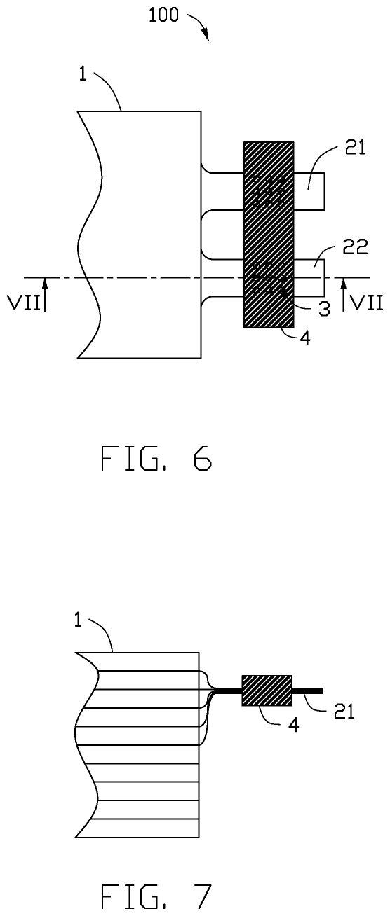

Referring to FIG. 5 and FIG. 6, when the first electrode plate 10 and the second electrode plate 20 are assembled to form the battery cell 100, the plurality of first tab pieces 2 are stacked and fixedly connected by an adhesive 4 to form a first tab unit 21. The plurality of second tab pieces are stacked and fixedly connected by the adhesive 4 to form a second tab unit 22. The polarity of the first tab unit 21 is opposite to the polarity of the second tab unit 22. The first electrode plate 10 and the second electrode plate 20 may be, but not limited to being, wound or laminated to form the battery cell 100. Referring to FIG. 2, a separator 50 is further positioned between the first electrode plate 10 and the second electrode plate 20. When the first electrode plate 10 and the second electrode plate 20 are wound or laminated to form the battery cell 100, the plurality of first tab pieces 2 are stacked to form the first tab unit 21, and the plurality of second tab pieces are stacked to form the second tab unit 22. The separator 50 is an insulating member, which avoids short circuit between the first electrode plate 10 and the second electrode plate 20.

In the present embodiment, the first tab unit 21 and the second tab unit 22 extend from the same side of the battery cell 100, and are arranged side by side. In other embodiments, the first tab unit 21 and the second tab unit 22 may be, but are not limited to, extended from different sides of the battery cell 100.

Each of the first tab piece 2 and the second tab piece defines a plurality of through holes 3. The through holes 3 are substantially located in a middle portion of each of the first tab piece 2 and the second tab piece. Therefore, the first tab unit 21 and the second tab unit 22 are provided with the through holes 3. The adhesive 4 is disposed at a position where the through holes 3 located and fills the through holes 3.

Referring to FIG. 7, in the battery cell 100, the first tab pieces and the second tab pieces are stacked and pressed together to form the first tab unit 21 and the second tab unit 22. The adhesive 4 is disposed on the side surface of the first tab unit 21 and the second tab unit 22, and the adhesive 4 is melted by high temperature to bond and fix together the plurality of the first tab pieces constituting the first tab unit 21 and the plurality of the second tab pieces constituting the second tab unit 22. The adhesive 4 fills most of the through holes 3 to reinforce the fixing and connection between the tab pieces. In the present embodiment, the first tab unit 21 and the second tab unit 22 can be integrally bonded by the adhesive 4 to simplify the process of manufacturing battery. That is, the first tab unit 21 and the second tab unit 22 are fixedly connected by the adhesive 4. To avoid short circuits between the first tab unit 21 and the second tab unit 22, the adhesive 4 is a non-conductive material.

In other embodiments, sheet-like adhesives 4 can be inserted between any adjacent two of the first tab pieces and second tab pieces before pressing the first tab pieces and second tab pieces together. The first tab unit 21 and the second tab unit 22 are formed by pressing and heating the adhesives 4 to connect the plurality of first tab pieces and the second tab pieces. The adhesive 4 between any adjacent first tab pieces or second tab pieces may be integrally connected through the through holes 3, thereby reinforcing the fixing and connection between the first tab pieces and the second tab pieces. In another embodiment, the first tab pieces and the second tab pieces may not contain through holes or only some portions of them may define through holes. The first tab pieces or the second tab pieces may be directly bonded and fixed by the adhesive 4.

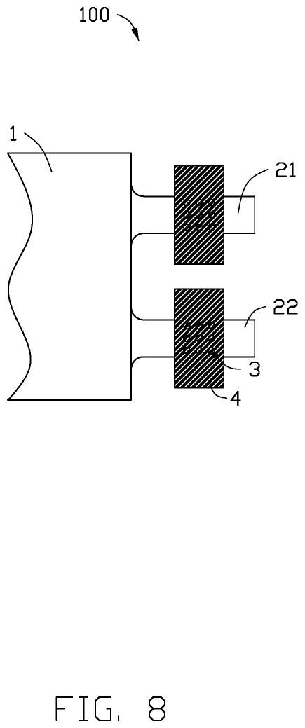

Referring to FIG. 8, in another embodiment, the plurality of the first tab pieces and the plurality of the second tab pieces may be separately bonded by the adhesives 4 to form the first tab unit 21 and the second tab unit 22. The adhesive 4 which is disposed on the first tab unit 21 does not contact the adhesive 4 provided on the second tab unit 22. Therefore, such adhesive 4 can be made of a conductive material instead of a non-conductive material.

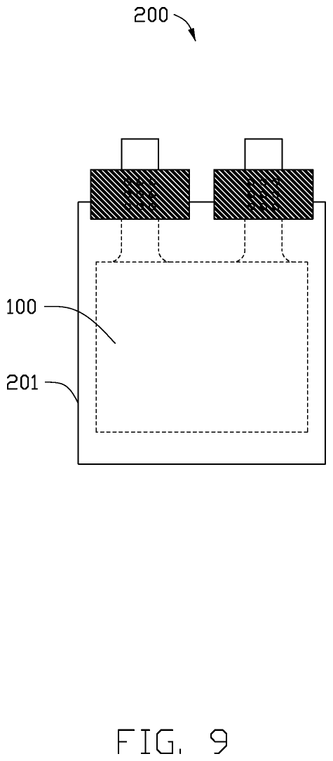

Referring to FIG. 9, the first tab unit 21 and the second tab unit 22 extend out of the package case 201 of the battery 200, and the first tab unit 21 and the second tab unit 22 extend from the same side of the battery 200. In another embodiment, a part of the first tab unit 21 and the second tab unit 22 extends out of the package case 201 and are coated by the adhesive 4. In other embodiments, the first tab unit 21 and the second tab unit 22 may extend from different sides of the battery 200, not being limited thereto.

The battery cell 100 and the battery 200 of the present application reduce the space occupied by the tab unit by directly arranging the tab unit on the current collector of the first electrode plate and/or the second electrode plate without soldering an additional tab unit. Energy density of the battery is thus increased. The soldering process is not required, and the problem of heat generation from the tab unit is solved. The stacked tab pieces increase the heat dissipation area of the tab unit and prevent the battery from overheating.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A battery, comprising:
a package case; and
a first electrode plate disposed in the package case, the first electrode plate comprising a current collector for connecting to an active material layer;
wherein the current collector is provided with a plurality of first tab pieces;
the plurality of first tab pieces are stacked and connected together to form a first tab unit, and a part of the first tab unit extends out of the package case.

2. The battery of claim 1, wherein the plurality of first tab pieces are connected together by an adhesive.

3. The battery of claim 2, wherein each first tab piece defines a plurality of through holes, and the adhesive is disposed at a position where the plurality of through holes are located and fills the plurality of through holes of the plurality of first tab pieces.

4. The battery of claim 2, wherein the adhesive is disposed on a side surface of the first tab unit.

5. The battery of claim 2, wherein the adhesive is disposed between adjacent two of the plurality of first tab pieces.

6. A battery, comprising:
a package case; and
a first electrode plate disposed in the package case, the first electrode plate comprising a current collector for connecting to an active material layer;
wherein the current collector is provided with a plurality of first tab pieces;
the plurality of first tab pieces form a first tab unit, a part of the first tab unit extends out of the package case and is coated by an adhesive.

7. The battery of claim 6, wherein the battery comprises a second electrode plate, the second electrode plate having a polarity opposite to a polarity of the first electrode plate;
the second electrode plate comprises a current collector for connecting to an active material layer, and the current collector is provided with a plurality of second tab pieces; and
the plurality of second tab pieces are stacked and connected together to form a second tab unit, and the second tab unit extends out of the package case.

8. The battery of claim 7, wherein the plurality of the second tab pieces are connected together by an adhesive.

9. The battery of claim 8, wherein through holes are defined on each of the plurality of second tab pieces, the adhesive is disposed at a position where the through holes are located and fills the through holes of the plurality of second tab pieces.

10. The battery of claim 8, wherein, the adhesive is disposed on a side surface of the second tab unit.

11. The battery of claim 8, wherein the first tab unit and the second tab unit extend from a same side of the battery.

12. The battery of claim 8, wherein the adhesive is disposed between adjacent two of the plurality of second tab pieces.

13. The battery of claim 7, wherein the plurality of first tab pieces are connected together by an adhesive.

14. The battery of claim 13, wherein through holes are defined on each of the plurality of first tab pieces, and the adhesive is disposed at a position where the through holes are located and fills the through holes of the plurality of first tab pieces.

15. The battery of claim 13, wherein the adhesive is disposed on a side surface of the first tab unit.

16. The battery of claim 13, wherein the adhesive is disposed between adjacent two of the first tab pieces.

17. The battery of claim 7, wherein, the battery comprises a battery cell, the first electrode plate and the second electrode plate are wound or laminated to form the battery cell.

18. The battery of claim 17, wherein, the battery cell comprises a separator, the separator is positioned between the first electrode plate and the second electrode plate.

19. The battery of claim 7, wherein, the first tab unit and the second tab unit are integrally bonded by an adhesive.

20. The battery of claim 7, wherein, the plurality of first tab pieces are pressed together to form the first tab unit, and the plurality of second tab pieces are pressed together to form the second tab unit.
